(19) United States
(12) Patent Application Publication
(10) Pub. No.: US 2026/0204717 A1
(43) Pub. Date: Jul. 16, 2026

(54) BATTERY CELL AND FRAMELESS BATTERY

(71) Applicant: ASUSTeK COMPUTER INC., Taipei City (TW)

(72) Inventors: Chun-I Sun, Taipei City (TW); Yu-Hsiu Su, Taipei City (TW); Chia-Sen Chang, Taipei City (TW); Ying-Yui Wu, Taipei City (TW)

(73) Assignee: ASUSTeK COMPUTER INC., Taipei City (TW)

(21) Appl. No.: 19/440,663

(22) Filed: Jan. 6, 2026

(30) Foreign Application Priority Data
Jan. 15, 2025 (TW) 114101628

(51) Int. Cl. H01M 50/262; H01M 10/04; H01M 50/209; H01M 50/247

(52) U.S. Cl. CPC H01M 50/262; H01M 10/0431; H01M 50/209; H01M 50/247; H01M 2220/30

(57) ABSTRACT

A battery cell includes a hard casing, a jelly roll (in a winding or stacking manner), and multiple fixing structures. The jelly roll is disposed in the hard casing. The fixing structures are disposed on the hard casing separately from each other and are protruded from at least one surface of the hard casing. A frameless battery is also provided.

### CROSS-REFERENCE TO RELATED APPLICATION

This application claims the priority benefit of Taiwan application serial no. 114101628, filed on Jan. 15, 2025. The entirety of the above-mentioned patent application is hereby incorporated by reference herein and made a part of this specification.

### BACKGROUND

### Technical Field

The disclosure relates to a battery cell and a frameless battery, and more particularly, to a battery cell and a frameless battery with a fixing structure.

### Description of Related Art

Generally speaking, a battery of a notebook computer is disposed in a frame and fixed to a device body through the frame. However, the above configuration affects usable space of the battery in the device body. Therefore, how to increase the usable space of the battery in the device body to increase a battery capacity is a topic that is being discussed in the art.

### SUMMARY

The disclosure provides a battery cell, including a hard casing, a jelly roll or a hard casing including one or more jelly coils, and multiple fixing structures. The jelly roll is disposed in the hard casing. The fixing structures are disposed on the hard casing separately from each other and protruded from at least one surface of the hard casing.

The disclosure further provides a frameless battery, which is disposed in an external device, including at least one battery cell. Each of the battery cells includes a hard casing, a jelly roll, and multiple fixing structures. The jelly roll is disposed in the hard casing. The fixing structures is fixed to the hard casing and protruded from at least one surface of the hard casing. The frameless battery is suitable for being fixed to the external device through the fixing structures of each of the battery cells, and the at least one battery cell is not additionally provided with a battery cell frame.

Based on the above, the battery cell of the frameless battery in the disclosure includes the hard casing and the fixing structures disposed in the hard casing, so that the battery cell and the frameless battery may be directly fixed to the external device through the fixing structures. Accordingly, compared to the existing battery cell and battery with the frame, the battery cell and the frameless battery in the disclosure have larger usable space in the external device. Accordingly, the battery cell and the frameless battery in the disclosure may have a larger battery capacity.

### BRIEF DESCRIPTION OF THE DRAWINGS

FIG. 1 is a schematic view of a frameless battery disposed in an external device according to an embodiment of the disclosure.

FIG. 2 is a schematic enlarged view of the frameless battery in FIG. 1.

FIG. 3 is a schematic view of a battery cell according to another embodiment of the disclosure.

FIG. 4 is a schematic view of a battery cell according to another embodiment of the disclosure.

FIG. 5 is a schematic view of a battery cell according to another embodiment of the disclosure.

FIG. 6 is a schematic view of a battery cell according to another embodiment of the disclosure.

### DETAILED DESCRIPTION OF DISCLOSED EMBODIMENTS

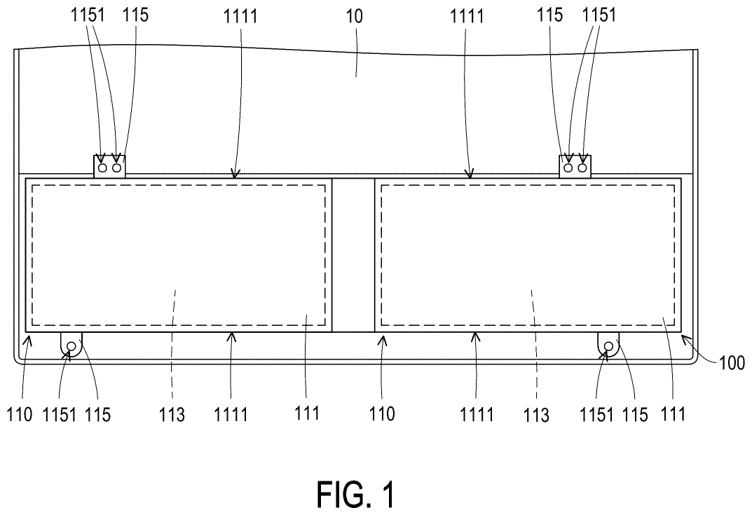

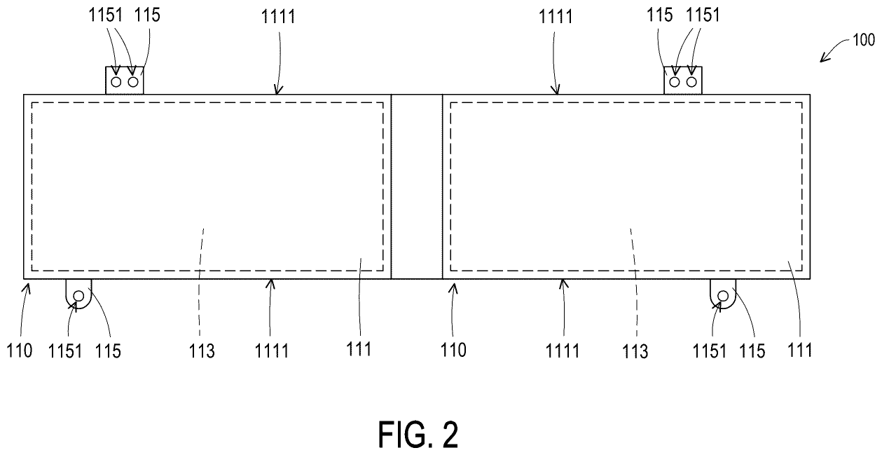

FIG. 1 is a schematic view of a frameless battery disposed in an external device according to an embodiment of the disclosure. FIG. 2 is a schematic enlarged view of the frameless battery in FIG. 1. Referring to FIGS. 1 and 2, a frameless battery 100 is disposed in an external device 10 and includes at least one battery cell 110 (two are shown). The battery cells 110 are electrically connected to each other, for example, in series or in parallel.

In detail, each of the battery cells 110 includes a hard casing 111, a jelly roll 113 (in a winding or stacking manner), and multiple fixing structures 115. The jelly roll 113 is disposed in the hard casing 111. The fixing structures 115 are fixed to the hard casing 111 and are protruded from at least one surface 1111 of the hard casing 111. The frameless battery 100 is suitable for being fixed to the external device 10 (such as a notebook computer) through the fixing structures 115 of each of the battery cells 110, and there is no additional battery cell frame outside the at least one battery cell 110.

In this embodiment, a material of the hard casing 111 is, for example, stainless steel, but the material of the hard casing 111 is not limited thereto. In addition, in the disclosure, the number of battery cells 110 included in the frameless battery 100 is not limited. In other embodiments, the number of battery cells 110 included in the frameless battery 100 may also be one, three, or four, for example.

In this embodiment, the number of fixing structures 115 of each of the battery cells 110 is two, and each of the fixing structures 115 includes at least one through hole 1151. A user may, for example, fix each of the battery cells 110 to the external device 10 by passing a screw through the through hole 1151 and fixing it to the external device 10. The number of fixing structures 115 and a form of the fixing structures 115 are not limited thereto.

In this embodiment, the at least one surface 1111 of the hard casing 111 includes two opposite surfaces 1111, and the fixing structures 115 are staggeredly disposed on the surfaces 1111. In an embodiment, the two fixing structures 115 on a right side of the frameless battery 100 shown in FIG. 2 are respectively located on the two opposite surfaces 1111 and staggered from each other in a left-right direction. The disposing position of the fixing structures 115 is not limited thereto. In other embodiments, the disposing position of the fixing structures 115 may be adjusted according to an internal structure of the external device 10.

In this embodiment, the fixing structures 115 of each of the battery cells 110 and the hard casing 111 are integrated, for example. That is to say, a material of the fixing structure 115 is also stainless steel, for example, but the disclosure is not limited thereto. In other embodiments, the fixing structures 115 of each of the battery cells 110 may also be connected to the hard casing 111 through welding, screwing, bonding, or engaging, and the material of the fixing structure 115 may also be different from the material of the hard casing 111.

Table 1 is a comparison table of sizes and capacities of the battery cell between a conventional battery and a frameless battery. Referring to Table 1, the battery cell 110 of the frameless battery 100 in the disclosure has a longer width and length than the conventional battery, so that the battery cell 110 has a larger battery capacity.

TABLE 1
Comparison table of sizes and capacities of the battery cell
between a conventional battery and a frameless battery

| | | Battery | Battery | Battery | Battery | 4S1P |
|---|---|---|---|---|---|---|
| | Frame | cell | cell | cell | cell | battery |
| | thickness | thickness | width | length | capacity | capacity |
| | (mm) | (mm) | (mm) | (mm) | (Wh) | (Wh) |
| Conventional | 1.5 | 4.218 | 51 | 139 | 22.5 | 90 |
| battery | | | | | | |
| Frameless | frameless | 4.218 | 54 | 140.5 | 24.34 | 93.36 |
| battery | | | | | | |

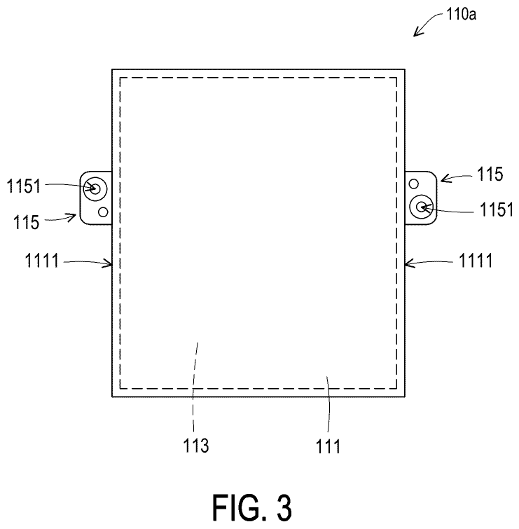

FIG. 3 is a schematic view of a battery cell according to another embodiment of the disclosure. Referring to FIG. 3, a difference between a battery cell 110a in this embodiment and the battery cell 110 in the previous embodiment is that the fixing structures 115 of the battery cell 110a in this embodiment are symmetrically disposed on the two opposite surfaces 1111, and the battery cell 110a may be fixed to the external device 10 shown in FIG. 1 through the fixing structures 115. In addition, length and width dimensions of the battery cell 110a in this embodiment are schematically illustrated, and are not limited to the drawing. In other embodiments, the length and width dimensions of the battery cell 110a may also be the same as those of the battery cell 110 shown in FIG. 1, or battery cells of any other length and width dimensions.

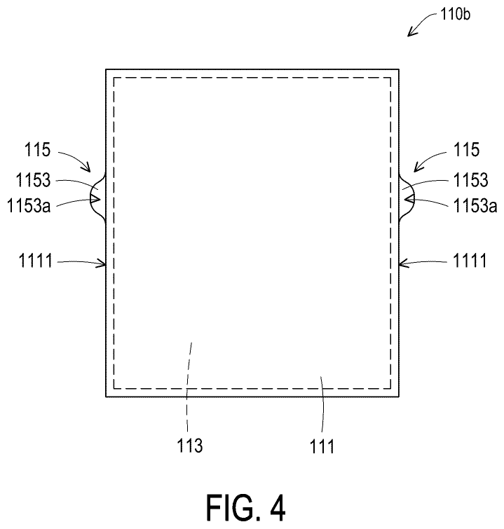

FIG. 4 is a schematic view of a battery cell according to another embodiment of the disclosure. Referring to FIG. 4, a difference between a battery cell 110b in this embodiment and the battery cell 110 in the previous embodiment is that the fixing structures 115 of the battery cell 110b in this embodiment respectively include an engaging member 1153, and each of the engaging members 1153 includes a limiting protrusion 1153a. In an embodiment, the battery cell 110b in this embodiment may be placed in the external device 10 along a direction of injection into a paper surface shown in FIG. 1, and engaged with a concave portion (not shown) of the external device through the limiting protrusion 1153a, so that the battery cell 110b is limited on the external device 10 in an up-down direction and the left-right direction shown in FIG. 1. In addition, length and width dimensions of the battery cell 110b in this embodiment are schematically illustrated, and are not limited to the drawing. In other embodiments, the length and width dimensions of the battery cell 110b may also be the same as those of the battery cell 110 shown in FIG. 1, or battery cells of any other length and width dimensions.

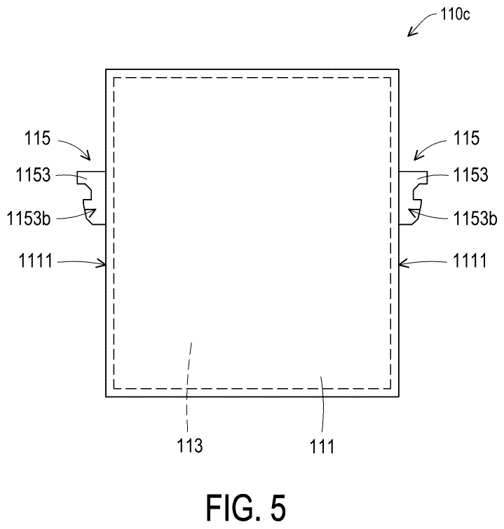

FIG. 5 is a schematic view of a battery cell according to another embodiment of the disclosure. Referring to FIG. 5, a difference between a battery cell 110c in this embodiment and the battery cell 110b in the previous embodiment is that that the engaging members 1153 of the fixing structures 115 of the battery cell 110c in this embodiment respectively include a hook 1153b. For example, the battery cell 110c in this embodiment may be placed into the external device 10 along the direction of injection into the paper surface shown in FIG. 1, and engaged with an engaging portion (not shown) of the external device 10 through the limiting protrusion 1153a. Alternatively, the battery cell 110c may, for example, be placed into the external device in the left-right direction as shown in FIG. 1, and engaged with an elastic piece (not shown) of the external device 10 through the hook 1153b, so that the battery cell 110c is limited on the external device 10 in the up-down direction and the left-right direction shown in FIG. 1. In addition, length and width dimensions of the battery cell 110c in this embodiment are schematically illustrated, and are not limited to the drawing. In other embodiments, the length and width dimensions of the battery cell 110c may also be the same as those of the battery cell 110 shown in FIG. 1, or battery cells of any other length and width dimensions.

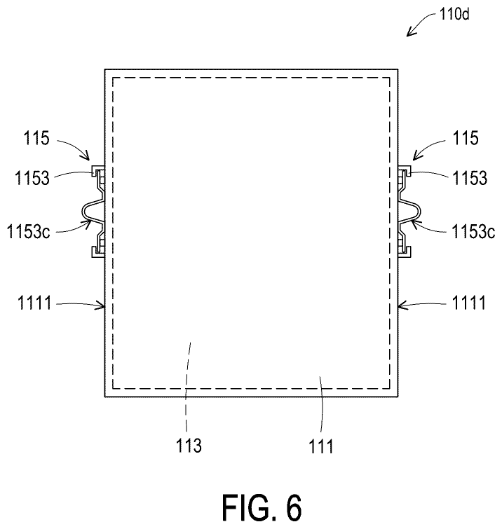

FIG. 6 is a schematic view of a battery cell according to another embodiment of the disclosure. Referring to FIG. 6, a difference between a battery cell 110d in this embodiment and the battery cell 110b in the previous embodiment is that that the engaging members 1153 of the fixing structures 115 of the battery cell 110d in this embodiment respectively include a bent elastic piece 1153c. For example, the battery cell 110d in this embodiment may be placed in the external device 10 in the left-right direction as shown in FIG. 1, and engaged with the engaging portion (not shown) of the external device 10 through the bent elastic piece 1153c, so that the battery cell 110d is limited on the external device 10 in the up-down direction and the left-right direction shown in FIG. 1. In addition, length and width dimensions of the battery cell 110d in this embodiment are schematically illustrated, and are not limited to the drawing. In other embodiments, the length and width dimensions of the battery cell 110d may also be the same as those of the battery cell 110 shown in FIG. 1, or battery cells of any other length and width dimensions.

It should be noted that the hard casings 111 of the battery cells 110, 110a, 110b, 110c, and 110d in the above embodiments may be designed to be charged or uncharged. If the hard casing 111 is designed to be charged, and the engaging member 1153, the limiting protrusion 1153a, the hook 1153b, and the bent elastic piece 1153c are all made of conductive materials, the engaging member 1153, the limiting protrusion 1153a, the hook 1153b, and the bent elastic piece 1153c may be insulated by insulating materials or processing methods, such as an anodic process, coating injection, applying insulation glue, insulation pads to achieve a purpose of insulating from the external device 10.

Based on the above, the battery cell of the frameless battery in the disclosure includes the hard casing and the fixing structures disposed in the hard casing, so that the battery cell and the frameless battery may be directly fixed to the external device through the fixing structures. Accordingly, compared to the existing battery cell and battery with the frame, the battery cell and the frameless battery in the disclosure have larger usable space in the external device. Accordingly, the battery cell and the frameless battery in the disclosure may have a larger battery capacity.

What is claimed is:

1. A battery cell, comprising:
a hard casing;
a jelly roll disposed in the hard casing; and
a plurality of fixing structures disposed on the hard casing separately from each other and protruded from at least one surface of the hard casing.

2. The battery cell according to claim 1, wherein at least one of the fixing structures comprises a through hole.

3. The battery cell according to claim 1, wherein at least one of the fixing structures comprises an engaging member, and the engaging member comprises a limiting protrusion, a hook, or a bent elastic piece.

4. The battery cell according to claim 1, wherein the at least one surface of the hard casing comprises two opposite surfaces, and the fixing structures are symmetrically disposed on the two surfaces.

5. The battery cell according to claim 1, wherein the at least one surface of the hard casing comprises a plurality of surfaces, and the fixing structures are staggeredly disposed on the surfaces.

6. The battery cell according to claim 1, wherein the fixing structures are integrated with the hard casing.

7. The battery cell according to claim 1, wherein the fixing structures are welded, screwed, bonded, or engaged to the hard casing.

8. A frameless battery, disposed in an external device, comprising:
at least one battery cell, wherein each of the battery cells comprises:
a hard casing;
a jelly roll disposed in the hard casing; and
a plurality of fixing structures fixed to the hard casing and protruded from at least one surface of the hard casing, wherein the frameless battery is suitable for being fixed to the external device through the fixing structures of each of the battery cells, and the at least one battery cell is not additionally provided with a battery cell frame.

9. The frameless battery according to claim 8, wherein the at least one battery cell comprises a plurality of battery cells connected in series or parallel, at least one of the fixing structures of each of the battery cell comprises a through hole or an engaging member, and the engaging member comprises a limiting protrusion, a hook, or a bent elastic piece.

10. The frameless battery according to claim 8, wherein the fixing structures of each of the battery cells are integrated with the hard casing, or the fixing structures of each of the battery cells are welded, screwed, bonded or engaged to the hard casing.
